(19) United States
(12) Patent Application Publication
(10) Pub. No.: US 2023/0278200 A1
(43) Pub. Date: Sep. 7, 2023

(54) SYSTEM AND METHOD TO EMULATE HUMAN COGNITION IN ARTIFICIAL INTELLIGENCE USING BIO-INSPIRED PHYSIOLOGY SIMULATION

(71) Applicant: David Franklin Hanson, JR., Richardson, TX (US)

(72) Inventor: David Franklin Hanson, JR., Richardson, TX (US)

(21) Appl. No.: 17/685,081

(22) Filed: Mar. 2, 2022

(51) Int. Cl. B25J 9/16; B25J 11/00

(52) U.S. Cl. CPC B25J 9/163; B25J 9/161; B25J 9/1671; B25J 11/001; B25J 11/0015

(57) ABSTRACT

An AI enabled human emulation system, a method, and a computer program product may be provided for embodied cognition with humanoid robot hardware (robot) to emulate human behavior. The system may include a memory configured to store computer program code and a processor configured to execute the computer program code to employ common sense reasoning, in much the same holistic way that humans do. The processor may be configured to obtain a trained AI model and sensor data from a surrounding environment of the robot. The AI model is trained using a brain emulation system and a human body physiology simulation system. The processor may be further configured to generate novel emergent pattern data to self-regulate the robot. The processor may also be configured to control the robot that interacts with a user by expressing a behavior to the user.

### TECHNOLOGICAL FIELD

The present disclosure generally relates to robotics and more particularly to artificial intelligence enabled cognitive systems.

### BACKGROUND

Generally, Artificial Intelligence (AI) entails performing humanlike tasks in various applications such as helping to make businesses more efficient decisions by data analytics and performing information services with people in natural humanlike conversational interactions. Even today, the AI and robots are not nearly as smart and adaptive as even basic organisms. Organisms are holistic systems, which are borne of mathematical emergence, and depend on emergence to generate novel responses to adapt to an environment. Existing AI generally suffers from various disadvantages when trying to implement holistic organism-inspired systems. A holistic organism-inspired systems approach may be key to general intelligence in machines. In certain other scenarios, AI may be incapable of realistically producing appropriate facial expressions or other non-verbal communications when trying to mimic a human. In certain other scenarios, background knowledge in real world situations may often be inconsistent, making it impossible for systems depending on binary truth values to find meaning across often inconsistent real-world domains.

In neuroscience, the mind-body connection appears critical to consciousness and general intelligence. Mind and body work together to create consciousness and intelligence. Hence, intelligence is not just in brain. Without brain simulation and without body physiological simulation, Artificial General Intelligence cannot be achieved.

### BRIEF SUMMARY

There is a need for a system and a method having embodied cognition with a humanlike physiology that may help AI learn in a more humanlike way, and therefore be smarter, and in ways closer to life. Further, there is a need for a system and method to employ common sense reasoning, in much the same holistic way that humans do.

A system, a method, and a computer program product are provided herein that focuses on an AI enabled human emulation to control a robot to employ common sense reasoning, in much the same holistic way that humans do.

The disclosed system architects the robot and AI in such a way that the robot gets better with people and also understands them better. The disclosed system models a non-brain physiology and uses it to inform the brain architecture to create an AI enabled human emulation system that can model what means to be human. In accordance with an embodiment, AI model is trained with machine learning to grow in a way similar to a human.

In one aspect, the AI enabled human emulation system to control a robot may be provided. The AI enabled human emulation system may include at least one non-transitory memory configured to store computer program code, and at least one processor (hereinafter referred as processor) configured to execute the computer program code to obtain a trained AI model and sensor data from a surrounding environment of the robot. The AI model may be trained using brain emulation data and human body physiology simulation data. The processor may be configured to generate novel emergent pattern data to self-regulate the robot a based on the trained AI model and the sensor data. The processor may be further configured to control the robot that interacts with a user by expressing a behavior to the user, based on the novel emergent pattern data.

According to some example embodiments, the trained AI model may be selected from a plurality of trained AI subgroups. The plurality of trained AI subgroups may comprise a brain emulation system and a human body physiology simulation system for embodied cognition with a humanlike physiology that facilitates training of the AI model in a more humanlike way.

According to some example embodiments, the brain emulation system may be further configured to determine the concepts associated with neurons of the brain, associate the concepts with predetermined meanings of the brain emulation system and other trained AI models associated with the human body physiology simulation, and relate the meaning to user specific goals.

According to some example embodiments, the human body physiology simulation system may be further configured to determine user physiology states based on the sensor data, generate robot physiology state data based on the determined user physiology states, calculate, by the trained AI model, a plurality of output behavior weights based on the user physiology states and one or more rules associated with the human body physiology simulation system, and control the robot that interacts with the user, based on the plurality of output behavior weights and the robot physiology state data.

According to some example embodiments, the user physiology states correspond to at least one of hormones state, metabolism state, cardiovascular state, breathing rate, endocrine state, and dopamine state.

According to some example embodiments, the robot physiology states may be further based on feelings associated with the user physiology states for survival and learning, and wherein the feelings correspond to at least one of fearfulness, happiness, sadness, desire, pleasure, and pain.

According to some example embodiments, the survival and learning in the human body physiology simulation system may be mapped to the brain emulation system in the AI model trained for general intelligence in the robot.

According to some example embodiments, the expressed behavior of the robot may comprise spoken words and actuation of one or more of end effectors of the robot.

According to some example embodiments, the trained AI model may comprise at least one of a machine learning model, a deep learning model, a knowledge processing model, a computational model that may approximate function of human biology system, perception algorithm or a bio-inspired engineered algorithm.

Embodiments disclosed herein may provide a method for human emulation to control a robot may be provided. The method may include obtaining a trained AI model and sensor data from a surrounding environment of the robot, wherein the AI model is trained on the brain emulation data and human body physiology simulation data. The method further includes generating, by one or more processors, novel emergent pattern data to self-regulate the robot and adapt the robot to the surrounding environment based on the trained AI model and the sensor data. The method further includes controlling the robot that interacts with a user by expressing a behavior to the user, based on the novel emergent pattern data.

Embodiments of the present disclosure may provide a computer programmable product including at least one non-transitory computer-readable storage medium having computer-executable program code stored therein. The computer programmable product comprising a non-transitory computer readable medium having stored thereon computer executable instructions, which when executed by a computer, cause the computer to carry out operations, for obtaining a trained AI model and sensor data from a surrounding environment of the robot, wherein the AI model is trained on the brain emulation data and human body physiology simulation data, generating novel emergent pattern data to self-regulate and adapt to the surrounding environment based on the trained AI model and the sensor data, and controlling the robot that interacts with a user by expressing a behavior to the user, based on the novel emergent pattern data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a block diagram that illustrates an environment for operating a human emulation system to control a robot, in accordance with an example embodiment;

FIG. 2 illustrates a block diagram of the AI enabled human emulation system, exemplarily illustrated in FIG. 1, that may be used to control a robot, in accordance with an example embodiment;

FIG. 3 illustrates a flowchart for implementation of an exemplar method for controlling a robot, in accordance with an example embodiment;

FIG. 4 illustrates a flowchart for implementation of an exemplar method for controlling the robot using a brain emulation system, in accordance with an example embodiment;

FIG. 5 illustrates a flowchart for implementation of an exemplar method for controlling the robot using a human body physiology simulation system for embodied cognition, in accordance with an example embodiment; and

FIG. 6 illustrates an exemplar scenario for implementation of an AI enabled human emulation system deployed in a healthcare ecosystem to control a robot in a more humanlike way, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided herein in accordance with an example embodiment for a bio-inspired artificial intelligence enabled human emulation system that utilizes embodied cognition, with pattern emergence, bio-inspired physiology simulation, bio-inspired cognition, and a simulation of body as interface with environment, to learn, evolve, and perform intelligent tasks in at least partially unstructured environments.

More particularly, various embodiments of the present disclosure provide a set of elements analogous to those in living beings, including bio-inspired engineered elements, AI, an approximation of biological physiology which may include a brain emulation, human body physiology simulation (such as, artificial metabolism and an artificial cardiovascular state), sensors, algorithms (such as, perceptual algorithms), computing hardware, and mechanisms for interaction with an environment, to result in more adaptive, intelligence, and creative artificial intelligence. Another important technical advantage is that the disclosed system in the present disclosure may allow perception of emotional state of a human with which a robot is interacting and a simulated emotional response by the robot to better facilitate interaction between the robot and a human.

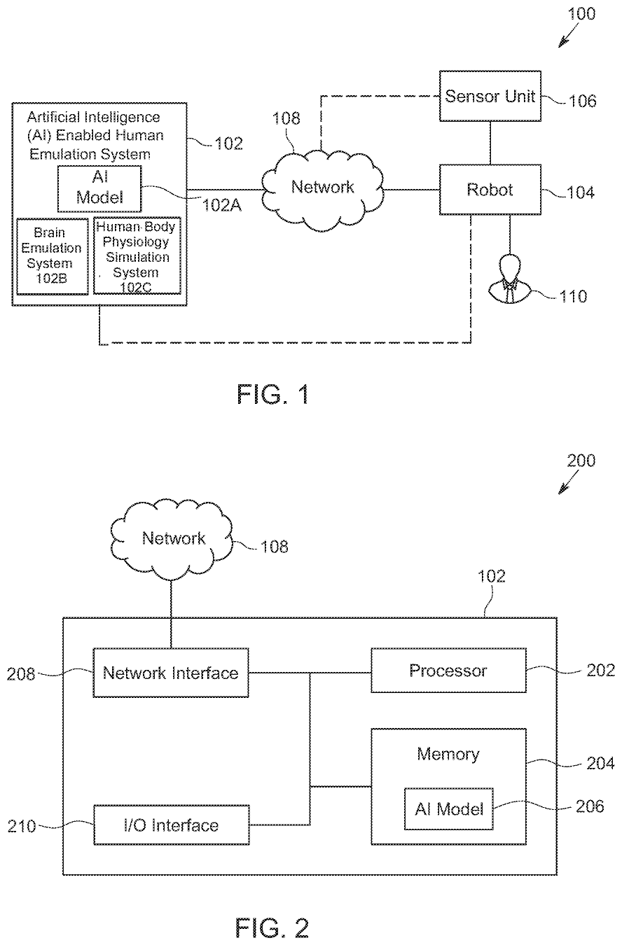

FIG. 1 is a block diagram that illustrates an environment 100 for operating a bio-inspired Artificial Intelligence (AI) enabled human emulation system to control a robot that interacts in a surrounding environment, in accordance with an example embodiment. There is shown an environment 100 that includes an AI enabled human emulation system 102, an AI model 102A, a robot 104, a sensor unit 106, and a network 108. There is further shown one or more users, such as a user 110 that interacts with the robot 104. The AI enabled human emulation system 102 may be communicatively coupled to the robot 104, via the network 108. In accordance with an embodiment, the AI enabled human emulation system 102 may be directly coupled to the robot 104. The AI model 102A may be a part of the AI enabled human emulation system 102. In accordance with an embodiment, the AI enabled human emulation system 102 may be communicatively coupled to the AI model 102A, via the network 108. The sensor unit 106 may be a part of the robot 104. In accordance with an embodiment, the sensor unit 106 may be communicatively coupled to the robot 104, via the network 108. The AI enabled human emulation system 102 may be communicatively coupled to the sensor unit 106 of the robot 104, via the network 108.

In some example embodiments, the AI enabled human emulation system 102 may be implemented in a cloud computing environment. In some other example embodiments, the AI enabled human emulation system 102 may be implemented in the robot 104. All the components in the environment 100 may be coupled directly or indirectly to the network 108. The components described in the environment 100 may be further broken down into more than one component and/or combined together in any suitable arrangement. Further, one or more components may be rearranged, changed, added, and/or removed.

The AI enabled human emulation system 102 may comprise suitable logic, circuitry, and interfaces that may be configured to obtain the AI model which may be trained (hereinafter also referred as trained AI model 102A) from a third-party entity, such as a service provider for AI models. The AI model is trained using brain emulation data and human body physiology simulation data. Further, the AI enabled human emulation system 102 may be configured to obtain sensor data from a surrounding environment of the robot 104. Further, the AI enabled human emulation system 102 is configured to generate novel emergent pattern data to self-regulate the robot 104. The novel emergent pattern data is generated based on the trained AI model and the sensor data. The AI enabled human emulation system 102 is further configured to control the robot 104 for enabling interaction between the robot 104 and the user 110. The robot 104 interacts with the user 110 by expressing a behavior to the user 110 based on the novel emergent pattern data. The robot may possess human like intellectual abilities, such as ability to learn anything, ability to reason, ability to use language and ability to formulate original ideas. In an example embodiment, the AI enabled human emulation system 102 may be a server, group of servers, distributed computing system, and/or other computing system. In an example embodiment, the AI enabled human emulation system 102 may not be located onboard a robot, such as the robot 104. For example, the AI enabled human emulation system 102 may be in communication with the robot 104 via the network 108.

The robot 104 comprises suitable logic, circuitry, hardware components and interfaces that may be configured to receive user input, generate, and provide a request to the AI enabled human emulation system 102 associated with the user 110 that comprises the sensor data, receive a response from the AI enabled human emulation system 102, generate an output to provide to a user (such as the user 110). The sensor data may comprise, but not limited to, visual data, audio data, and speech data. The robot 104 may be configured to aid the users (such as, the user 110) autonomously in a safe and resilient manner among other services. The robot 104 may be communicatively coupled to a user, such as, the user 110. The robot 104 that may be controlled by the AI enabled human emulation system 102 by using the trained AI model 102A may employ common sense reasoning, in much the same holistic way that humans do.

The sensor unit 106 may comprise suitable logic, circuitry, and interfaces that may be configured to provide the sensor data to the AI enabled human emulation system 102. In accordance with an embodiment, the sensor data may also be obtained from internal environment of the robot 104. In an example embodiment, the sensor data from the sensor unit 106 allows the robot 104 to detect an object or an event in the surrounding environment of the robot 104. Examples of the sensor data include, but may not be limited to, data from cameras or image capturing sensors (video sensors) installed in eyes of the robot 104, data from various sensors, such as, but not limited to, proximity sensors, tactile sensors, olfactory sensors, touch sensors, velocity sensors, positioning sensors, infrared sensors, ultra-sound sensors, and echo-location sensors. The sensor unit 106 may be configured to filter and normalize the sensor data using any suitable technique for filtering and normalizing to reduce noise and saturation of the sensor data. In accordance with an embodiment, the AI enabled human emulation system 102 may be configured to filter and normalize the sensor data from the sensor unit 106. To decide meaningful responses to sensory perceptions from the sensor unit 106, the AI enabled human emulation system 102 may employ, but not limited to, Expert Knowledge Systems, Automatic Speech Recognition systems, Natural Language Processing systems, bio-inspired deep learning, logical reasoning systems, connectome based computational neural simulations, chemical metabolic physiology simulations, and/or statistical reasoning systems. The AI enabled human emulation system 102 may be configured to employ, but not limited to, face-tracking machine vision, audio-sensing, facial biometrics, electronic chemical sensing (smell), and touch sensing to sense and perceive natural human communication signals received by the sensor unit 106.

The network 108 may comprise suitable logic, circuitry, and interfaces that may be configured to provide a plurality of network ports and a plurality of communication channels for transmission and reception of data, such as the sensor data. Each network port may correspond to a virtual address (or a physical machine address) for transmission and reception of the communication data. For example, the virtual address may be an Internet Protocol Version 4 (IPv4) (or an IPv6 address) and the physical address may be a Media Access Control (MAC) address. The network 108 may include a medium through which the AI enabled human emulation system 102, and/or the other components may communicate with each other. The network 108 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 108 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long-Term Evolution (LTE) network, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

In operation, the AI enabled human emulation system 102 may be configured to receive a request from the robot 104 to facilitate interaction between the robot 104 and a human (such as the user 110). The AI enabled human emulation system 102 may be configured to obtain the trained AI model 102A and the sensor data from the sensor unit 106 based on the surrounding environment of the robot 104. The sensor data may be associated with a user 110 who wants to interact with the robot 104. The robot 104 may be controlled by the AI enabled human emulation system 102. In accordance with an embodiment, the surrounding environment may be an unstructured and complex environment. The AI enabled human emulation system 102 may dynamically adapt and self-regulate to unpredictable interaction with the surrounding environment. In accordance with an embodiment, the sensor data may also be obtained from internal environment of the robot 104. In accordance with an embodiment, the sensor data may be used by the robot 104 to detect an object or an event in the surrounding environment. Examples of the sensor data may include, but not limited to, data from cameras or image capturing sensors installed in eyes of the robot 104, proximity sensors and tactile sensors. The sensor data may be filtered and normalized using any suitable technique for filtering and normalizing for reduction of noise and saturation.

In accordance with an embodiment, the AI enabled human emulation system 102 may transmit the sensor data to the AI model 102A of the AI enabled human emulation system 102 to achieve human like cognition. High quality signals from sensors of the sensor data, positioning of the sensors on the robot 104 may aid in obtaining information from the surrounding environment of the sensor unit 106. In accordance with an embodiment, the sensor data affects motor output of the robot 104. The trained AI model 102A is selected from a plurality of trained AI subgroups. In addition, the plurality of trained AI subgroups comprises a brain emulation system 102B and a human body physiology simulation system 102C. In an embodiment of the present disclosure, the brain emulation system 102B and the human body physiology simulation system 102C are installed inside the AI enabled human emulation system 102. The AI model 102A of the AI enabled human emulation system 102 may be trained using brain emulation data and human body physiology simulation data that facilitates human-like cognition in the robot 104 making it robust, autonomous, and saving the robot 104 from self-destruction. The brain emulation data is received from the brain emulation system 102B. The human body physiology simulation data is received from the human body physiology simulation system 102C. The brain emulation system 102B and the human body physiology simulation system 102C are utilized for providing embodied cognition with a humanlike physiology that facilitates training of the AI model in a more humanlike way. Because of the human-like cognition, the AI enabled human emulation system 102 may help the robot 104 in venturing into human environment autonomously and successfully. Moreover, the robot 104 may possess morphology similar to that of a human, the sensors, and material used on the robot 104 may resemble that of a human. This facilitates the human like cognition in the robot 104 that depends on the sensor data obtained from sensor unit 106, physiology simulation, neural activity of brain and the surrounding environment. The architecture of the AI enabled human emulation system 102 may seamlessly integrate into neural activity and psychology. The AI enabled human emulation system 102 may be configured to mimic the human body physiology. However, considerable abstractions may be present with the underlying principles that remain same at a certain level of abstraction.

The AI model 102A may be built from underlying biophysical principles. In accordance with an embodiment, the AI model 102A may be integrated with other systems. For example, the AI model 102A may be configured to link other AI models of subsystems together to build models of integrated systems. In accordance with an embodiment, the AI model 102A for the AI enabled human emulation system 102 increases in size as more components become integrated with the AI model 102A. This may require formation of multi-institutional groups focusing on particular targets, which may include large sets of noisy and incomplete data. In accordance with an embodiment, computational models are used to decipher meaningful description of the AI enabled human emulation system 102.

In accordance with an embodiment, the AI model 102A may use deep architectures to learn complicated functions of high-level abstractions associated with brain, human body physiology and cognition. The deep architectures are composed of multiple levels of non-linear operations, such as in neural nets with many hidden layers, graphical models with many levels of latent variables. Each level of the architecture may represent features at a different level of abstraction, defined as a composition of lower-level features. The deep architectures may be trained by using learning algorithms, such as supervised learning algorithms. The AI model 102A may facilitate mimicking of human cognitive functions. The human cognitive functions may encompass many aspects of intellectual functions and processes such as attention, the formation of knowledge, memory and working memory, judgment and evaluation, reasoning and “computation”, problem solving and decision making, comprehension and production of language. The human cognitive functions may correspond to the mental processes that allow humans to receive, select, store, transform, develop, and recover information that they have received from external stimuli or surrounding environment which helps them to understand and to relate to the world more effectively. Learning is one of the examples of human cognitive functions. The AI model 102A may be configured to obtain the sensor data for particular features to select a plan suited in current context. The AI model 102A may use different AI subgroups in the AI model 102A to select best plan. Further, the AI model 102A may learn whether objects and events are newer, already known, based on the obtained sensor data.

The AI model 102A may be configured to capture complex non-linear relationships between the input (such as the sensor data) and an output (such as, controlling the robot 104). The trained AI model 102A may depict the associations between the output and the input through multiple hidden layer combinations of pre specified functions. The AI model 102A may estimate the weights (output weights) through input and output data so that the average error between the output and predictions is minimized. The AI model 102A may use standard optimization algorithms, such as, but not limited to, local quadratic approximation or gradient descent optimization.

The AI model 102A of the AI enabled human emulation system 102 may be trained by learning features from a large volume of sensor data, such as the sensor data obtained from the robot 104 and then use the insights obtained from the sensor data to assist the robot 104. The AI model 102A of the AI enabled human emulation system 102 may be equipped with learning and self-correcting abilities to improve accuracy based on feedback from the robot 104.

In accordance with an embodiment, the AI model 102A of the AI enabled human emulation system 102 is trained by machine learning (ML) methods that analyze structured data such as imaging data obtained from the sensor data. The AI model 102A with use of the ML methods may cluster traits of humans. In accordance with an embodiment, the supervised learning of the ML methods may be used for predictive modelling via building a relationship between the input (such as sensor data) and the output (such as, robot control action) by training the AI model 102A to determine the output associated with the input. Such supervised learning methods may be used, but not limited to, linear regression, logistic regression, naïve Bayes, decision tree, nearest neighbor, random forest, discriminant analysis, support vector machine (SVM) and neural network to train the AI model 102A.

In accordance with an embodiment, the AI model 102A of the AI enabled human emulation system 102 may be trained by second category includes natural language processing (NLP) methods that extract information from unstructured data to supplement and enrich structured data. The NLP procedures target at the unstructured data, such as, turning texts to machine-readable structured data, which may be analyzed by ML methods.

In accordance with an embodiment, the AI enabled human emulation system 102 is configured to adaptively seek and discover truth and discriminate falsehood by using computational models and artificial intelligence technologies that build hypotheses of possible truths, tests them, and composes the results into networks of larger estimated truths, building them into composite hypotheses like puzzle pieces, thereby bootstrapping knowledge from basic units into larger understandings, with the generalizing power of abstractions. The AI enabled human emulation system 102 may be configured to error correct the estimated truths by repeatedly testing and re-evaluating them and their composite knowledge models.

Furthermore, the AI enabled human emulation system 102 may be configured to recursively self-improve by applying its own truth-pursuit to evaluate and grow its own mechanisms of truth-pursuit; which is accomplished both by evaluating its techniques of truth pursuit with its own techniques of truth evaluation, and by creatively producing and testing new techniques, in pursuit of ever-better truth. These new techniques also get evaluated by truth tests of the AI enabled human emulation system 102. The self-improvement algorithms enable the AI enabled human emulation system 102 to strive to understand and improve it. By striving to understand and improve itself, the AI enabled human emulation system 102 may pursue truth better and better, and increasingly improve understanding of the very foundations of epistemology, truth, and reality.

In accordance with an embodiment, the trained AI model 102A may comprise at least one of a machine learning model, a deep learning model, a knowledge processing model, a computational model that approximates function of human biology system, perception algorithm or a bio-inspired engineered algorithm. To approximate the function of human biology system, software simulation of life may be performed by the AI model 102A. Apart from the biology systems, chemical systems and hybrid systems may be used by the AI model 102A of the AI enabled human emulation system 102 to simulate artificial life to control the robot 104. The AI model 102A may be configured to model the artificial life to decipher simple and general principles underlying life and implement them in a simulation to analyze lifelike systems, such as a brain emulation system 102B and a human body physiology simulation system 102C. In accordance with an embodiment, the AI model 102A of the AI enabled human emulation system 102 may store program-based simulations that include organisms with a complex DNA language. The AI model 102A may include rules corresponding to physical dynamics of lifelike systems. In accordance with an embodiment, the AI model 102A may establish ethical principles for artificial life.

The brain emulation system 102B for the trained AI model 102A may comprise elements and attributes associated with a brain. The elements may have trained relationship between concepts that have predetermined meanings. The brain emulation system 102B associated with the AI model 102A may determine concepts associated with neurons of the brain. In addition, the brain emulation system 102B is configured to associate the concepts with predetermined meanings of the brain emulation system 102B and the human body physiology simulation system 102C. The brain emulation system 102B associated with the AI model 102A is configured to map the predetermined meanings of the brain emulation system 102B and the human body physiology simulation system 102C with user specific goals. The neuroscience that deals about neurons in the brain emulation system mapping meaning with the user specific goals follows empirical studies on humans. In accordance with an embodiment, the trained AI model 102A follows computational methods. However, the trained AI model 102A based only on computational models may have limited capabilities. Hence, the trained AI model 102A that considers the brain simulation, human body physiology simulation and interaction with the surrounding environment, which is a real world, gives rise to complex behavioral patterns in the robot 104 that may be hard to predict, instead of being simple and deterministic patterns. Therefore, the AI enabled human emulation system 102 may be configured to generate novel emergent pattern data to self-regulate the robot 104 and adapt the robot 104 to the surrounding environment based on the trained AI model 102A and the sensor data. The generated novel emergent pattern data may be based on the trained AI model 102A that learns from experience.

The novel emergent pattern data may correspond to systematic consequence of interactions of sub systems, such as the brain emulation system 102B and the human body physiology simulation system 102C of the trained AI model 102A in the AI enabled human emulation system 102. A pattern in the novel emergent pattern data may have an emergent property because that may be a result of a systematic interaction of the sub systems in the AI enabled human emulation system 102. The AI enabled human emulation system 102 may behave like bio-inspired complex systems that exhibit unique, natural, and dynamic patterns that behave in unexpected ways, not predictable from the behavior of members of the bio-inspired complex systems. Such bio-inspired complex systems may operate as if they have organized and regulated themselves. Similarly, the “self-regulation” of the robot 104 may correspond to an emergent behavior caused by the actions of all individual sub systems, such as the brain emulation system and the human body physiology simulation system 102C of the trained AI model 102A within the AI enabled human emulation system 102 acting upon a fixed set of rules. The rules may correspond to different algorithms used by the AI enabled human emulation system 102. An algorithm may correspond to a list of the exact steps necessary to conduct a desired computation, a list that comes with a guarantee that the computation will stop with the correct answer. Generally, algorithms may require less information and space to operate than an equivalent table that lists all the possible outcomes of a computation. Such compacting of information may be a fundamental aspect of life. For example, DNA itself is a template of rules.

Further, the sub systems (such as, the brain emulation system 102B and the human body physiology simulation system 102C) of the trained AI model 102A within the AI enabled human emulation system 102 may be connected to the external environment (or surrounding environment) via the sensor unit 106 of the robot 104. Such connectivity may be essential for emergent behavior to exist.

The emergent behavior of the AI enabled human emulation system 102 may be more valuable and different than that of the sub systems (such as, the brain emulation system 102B and the human body physiology simulation system 102C trained by the AI model 102A). Yet, each sub system in the AI enabled human emulation system 102 may be configured to use a feedback loop to receive sensory input from the sensor unit 106, process the sensory input according to a fixed set of rules and then act upon the result. The combined action of all the sub systems using respective feedback loops may result in the generation of novel emergent pattern data of the AI enabled human emulation system 102. The AI enabled human emulation system 102 may exhibit emergent behavior from the generation of novel emergent pattern data that provides more complexity than the individual sub systems.

Examples of emergence in real world may be observed in insects which manage to undertake massive building projects, such as, hives and mounds. Non-living examples of emergence may include natural magnets that align themselves into a common North-South orientation and crystals forming from liquids showing a spontaneous increase in order. Therefore, generation of order manifested by patterns in nature is based on interaction of local elements in a system. Similarly, the interaction of sub systems from the trained AI model 102A in the AI enabled human emulation system 102 may result in generation of the novel emergent pattern data to self-regulate the robot 104. Small changes in the rules that govern local interactions between sub systems of the trained AI model 102A may cause huge changes in the novel emergent pattern data of the AI-enabled human emulation system 102.

The brain emulation system 102B for the trained AI model 102A employs general purpose learning methods based on human body physiology. The general-purpose learning methods may be used to work on the obtained sensor data and cognition power of the brain that aids in self-regulation of the robot 104. The brain emulation system 102B for the trained AI model 102A may provide the brain with continuous learning about the real world without forgetting concepts already learned from the past. The general-purpose learning methods may be integrated into neural circuitry of the brain emulation system such that the trained AI model may model emotions and motivations for human like cognitive functions. Thereby, the robot 104 may interact with the humans in surrounding environment, such as the user 110, at the same time keeping in mind the threats predicted by the AI enabled human emulation system 102 in the surrounding environment. The robot 104 may bond with the humans socially and learn using natural language processing (NLP). Therefore, the AI enabled human emulation system 102 may possess general intelligence to learn from people it interacts with, from data, such as the sensor data or the devices or systems the robot 104 interacts with for controlling the robot 104 in a similar way as a human brain acts in a situation that may include effects of emotions and feelings, motivation of humans for satisfaction, and working of natural life intelligence. Further, in accordance with another embodiment, based on simulated emotions in the robot 104, the AI enabled human emulation system 102 may control the robot 104 to speak with a certain pitch, tone, volume, and speed.

The robot 104 may form opinions of data obtained based on training of the AI model 102A in the AI enabled human emulation system 102. In accordance with an embodiment, for learning data, the AI enabled human emulation system 102 may use advanced pattern recognition algorithms to identify different patterns in sensor data, such as visual data, audio data, text data and image data. The AI enabled human emulation system 102 may learn to reason on what is good and bad similar to how humans examine new information. Based on the learning acquired by the AI enabled human emulation system 102, it can make predictions in different ways.

Similarly, the brain emulation system 102B for the AI model 102A may be configured to model other modalities, such as speaking, visualizing, and hearing. The visualization may be for complex scenes in the real world. Therefore, the AI enabled human emulation system 102 may be configured to control the robot 104 to identify objects in the surrounding environment from the sensor data. The identified objects may be comprehended in terms of size, shape, and color by the AI enabled human emulation system 102. In accordance with an embodiment, visual sensors may be used on the body of robot 102A to obtain the sensor data associated with visualization of the robot 104. The visual sensors may correspond to, but not limited to, pre-amplifiers working on infra-red radiations, radio waves, or radar waves electromagnetic frequencies. For speaking, the robot 104 may be installed with microphones that may be sensitive to ultra-sound frequencies.

In accordance with an embodiment, the AI enabled human emulation system 102 may be configured to use map data from map database stored in memory of the AI enabled human emulation system 102 for identification of self-location which makes the robot 104 capable of self-knowledge. The sensor data may be correlated to the self-knowledge capability of the AI enabled human emulation system 102. The AI enabled human emulation system 102 may control the robot 104 in such a manner that the robot behaves in a human-like way, such as, the robot 104 may hear and understand audio from the sensor data, sees from the visual data from the visual sensors to have experiential capabilities. Based on such experiential capabilities, the AI enabled human emulation system 102 may control the robot 104 to make a conclusion and act in real time for best outcome.

In accordance with an embodiment, the human body physiology simulation system 102C of the trained AI model 102A is configured to determine user physiology states based on the sensor data.

In accordance with an embodiment, the human body physiology simulation system 102C of the trained AI model 102A is further configured to generate robot physiology state data based on the determined user physiology states. In accordance with an embodiment, the robot physiology state mimic humans that are motivated for satisfaction. The satisfaction may correspond to, but not limited to, watching movie, eating favorite food, shopping, and sleeping. Features from the sensor data and context of dealing with the user in surrounding environment may be used by the human body physiology simulation system to mimic motivation for satisfaction.

In accordance with an embodiment, the human body physiology simulation system of the trained AI model 102A is further configured to calculate a plurality of output behavior weights based on the user physiology states and rules associated with the human body physiology simulation.

In accordance with an embodiment, the AI model 102A may be trained for pain and pleasures which are felt by humans and animals. The AI enabled human emulation system 102 cannot feel the pain and pleasure because of absence of nervous system and may be trained to feel the pain and the pleasure. Pain may correspond to reduction in efficiency of the AI enabled human emulation system 102 and pleasure may increase the efficiency of the AI enabled human emulation system 102.

In accordance with an embodiment, the AI enabled human emulation system 102 may be configured to control the robot 104 that interacts with the user 110. Such control of the robot 104 may be based on the plurality of output behavior weights and the robot physiology state data.

In accordance with an embodiment, the user physiology states may correspond to at least one of a hormones state, a metabolism state, a cardiovascular state, a breathing rate, an endocrine state, and a dopamine state. In an exemplary embodiment, the metabolism state of humans may be simulated in the human body physiology simulation system 102C associated with the AI model 102A, based on the sensor data from sensor unit 106. The simulated metabolism state of the robot 104 may be based on, but not limited to, hunger, thirst, rest, and feeling full after a hearty meal. In accordance with an embodiment, special hardware may be attached to the robot 104 for senses similar to humans. For example, the special hardware may be used for touch, smell, taste and feel and the corresponding data may be further processed by the trained AI model 102A. In an example, the robot 104 may identify any object just by touching it. The robot 104 may identify a hot object and a cold object by touching the object, just like humans.

The robot physiology states may be further based on feelings associated with the user physiology states for survival and learning. The feelings may correspond to at least one of fearfulness, anger, frustration, aggression, happiness, sadness, desire, pleasure, and pain. The survival and learning in the human body physiology simulation system 102C may be mapped to the brain emulation system 102B in the AI model 102A which may be trained for general intelligence in the robot 104. The robot 104 may identifies feelings of the user based on user behaviors. In an example, if a user is quiet for a long time and is crying silently, the robot 104 may identify that the user is sad. In another example, if a user is throwing away things (such as glass, mobile phone, tv remote), the robot 104 identifies that the user is in anger.

The AI enabled human emulation system 102 may be configured to control the robot 104 that interacts with a user (such as the user 110) by expressing a behavior to the user 110, based on the novel emergent pattern data. The expressed behavior may be for the user 110 interacting with the robot 104. In accordance with an embodiment, output from the AI enabled human emulation system 102 may be provided to external devices.

In accordance with an embodiment, the expressed behavior of the robot 104 may comprise spoken words and actuation of one or more of end effectors of the robot 104. In accordance with an embodiment, the expressed behavior of the robot 104 may comprise change in facial expressions, such as smile on the face of the robot. In accordance with an embodiment, the AI enabled human emulation system 102 may control the robot 104 where the robot 104 may communicate with users and devices by using audio technology, video technology, text messages, image technology or speech technology. In accordance with an embodiment, the robot 104 may ask for permission from the user 110 to do a certain task. In accordance with an embodiment, to emulate human communicative output, the AI enabled human emulation system 102 may be configured to employ synthesized spoken language and a physically embodied, 3D mechanical face that is humanlike in appearance and that may display at least some realistic human aesthetic structures, facial expressions, and/or gestures.

The AI enabled human emulation system 102 may be advanced by the coordinated integration of other display (or other output) technology in addition to said physically embodied, three-dimensional mechanical face. In some embodiments, this additional output technology may supplement the naturalistic communication with conventional computer graphics and text, and sound. In accordance with an embodiment, technology that produces various smells may also be used by the AI enabled human emulation system 102. In accordance with an embodiment, technology that produces tactile sensations may also be used by the AI enabled human emulation system 102. In accordance with an embodiment, technology that produces bodily gestures and/or locomotion may also be used by the AI enabled human emulation system 102.

FIG. 2 illustrates a block diagram 200 of the AI enabled human emulation system 102, exemplarily illustrated in FIG. 1 that may be used to control a robot, in accordance with an example embodiment. FIG. 2 is explained in conjunction with FIG. 1.

In the embodiments described herein, the AI enabled human emulation system 102 may include a processing means, such as, at least one processor (hereinafter interchangeably used with processor) 202, a storage means, such as, at least one memory (hereinafter interchangeably used with memory) 204, at least one AI model 206 which may be trained for brain emulation and human body physiology, a communication means, such as, at least one network interface (hereinafter interchangeably used with network interface) 208 and an I/O interface 210. The processor 202 may retrieve computer program instructions that may be stored in the memory 204 for execution of the computer program instructions. In accordance with an embodiment, the processor 202 is configured to obtain input (such as, sensor data from the robot 104), and render output (such as, robot control action) by training the AI model 206 to determine the output associated with the input from the user 110 that interacts with the robot 104.

The processor 202 may be configured to obtain sensor data from a surrounding environment of the robot 104. The processor 202 may be configured to structure and arrange the sensor data for processing. The processor 202 may be further configured to obtain a trained AI model 206. In accordance with an embodiment, the processor 202 of human emulation system 102 may generate AI model 206 and store in the memory 204. The AI model 206 may be trained on brain emulation and human body physiology simulation. In accordance with an embodiment, the processor 202 may be configured to generate novel emergent pattern data to self-regulate and adapt to the surrounding environment based on the trained AI model and the sensor data. The processor 202 may be further configured to control the robot 104 that interacts with the user 110 by expressing a behavior to the user, based on the novel emergent pattern data.

The processor 202 may be embodied in a number of different ways. The processor 202 may be a specialized processor designed specifically for use with the present disclosure. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the brain emulation system 102B.

Alternatively, as another example, when the processor 202 is embodied as an executor of software instructions, the instructions may specifically configure the processor 202 to perform the algorithms and/or operations described herein when the instructions are executed. However, in some cases, the processor 202 is a processor specific device (for example, a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The environment, such as, 100 may be accessed using the network interface 208. The network interface 208 may provide an interface for accessing various features and data stored in the robot 104 and the AI enabled human emulation system 102.

The memory 204 may be configured to store the sensor data obtained from the sensor unit 106 of the robot 104. The memory 204 may be configured to store the AI model 206 that may be trained and evaluated to control the robot 104 associated with the AI enabled human emulation system 102. In accordance with an embodiment, the AI model 206 may be trained by a third-party service provider and obtained by the processor 202 to be stored in the memory 204. In accordance with an embodiment, the AI model 206 may be trained by the AI enabled human emulation system 102. In accordance with an embodiment, the memory 204 may be configured to store software that is to be manipulated by commands to the processor 202. The memory 204 may be configured to store data that has to be transmitted by the AI enabled human emulation system 102 as an output to the robot 104 to control the robot 104. In accordance with an embodiment, the memory 204 is configured to store intermediate data used to conduct the steps of the AI enabled human emulation system 102. In accordance with an embodiment, the memory 204 includes processing instructions for training of the AI model 206 with training data sets that may be real-time data or historical data, from service providers.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, and instructions for enabling the AI enabled human emulation system 102 to conduct various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein. In accordance with an embodiment, the memory 202 is accessed using an encryption key for parameters such as the sensor data, location of the robot 104.

The AI model 206 (or trained AI model 206) may be trained on brain emulation and human body physiology simulation. The AI model 206 allows the AI enabled human emulation system 102 to generate novel emergent pattern data to self-regulate and adapt to the surrounding environment of the robot 104. The trained AI model 206 may be selected from a plurality of trained AI subgroups. The plurality of trained AI subgroups may comprise a brain emulation system 102B and a human body physiology simulation system 102C for embodied cognition with a humanlike physiology that facilitates training of the AI model 206 in a more humanlike way. The novel emergent pattern data may correspond to systematic consequence of interactions of sub systems, such as the brain emulation system 102B and the human body physiology simulation system 102C of the trained AI model 102A in the AI enabled human emulation system 102.

The network interface 208 may comprise suitable logic, circuitry, and interfaces that may be configured to communicate with the components of the AI enabled human emulation system 102 and other systems and devices in the environment 100, via the network 108. The network interface 208 may communicate with the robot 104 and the sensor unit 106, via the network 108 under the control of the processor 202. The network interface 208 may provide an interface for accessing various features and data stored in the AI enabled human emulation system 102. In some example embodiments, the network interface 208 may be configured to receive location data of the robot 104, via the network 108.

In some example embodiments, the I/O interface 210 may communicate with the robot 104 and displays input and/or output for the robot 104. In accordance with an embodiment, the input corresponds to presence and identification of an object in the surrounding environment of the robot 104 that may be transmitted to the AI enabled human emulation system 102, via the I/O interface 210. In accordance with an embodiment, the output corresponds to an audio message for the user 110 by controlling the robot 104 from the AI enabled human emulation system 102. The output may also be provided to other devices or other programs; e.g., to other software modules, for use therein.

As such, the I/O interface 210 may include a display and, in some embodiments, may also include a keyboard, a mouse, a joystick, a touch screen, touch areas, soft keys, one or more microphones, a plurality of speakers, or other input/output mechanisms. In one embodiment, the AI enabled human emulation system 102 may comprise user interface circuitry configured to control at least some functions of one or more I/O interface elements such as a display and, in some embodiments, a plurality of speakers, a ringer, one or more microphones and/or the like. The processor 202 and/or I/O interface 210 circuitry comprising the processor 202 may be configured to control one or more functions of one or more I/O interface 210 elements through computer program instructions (for example, software and/or firmware) stored on the memory 204 accessible to the processor 202.

In some embodiments, the processor 202 is configured to provide Internet-of-Things (IoT) related capabilities to users of the robot 104 disclosed herein. The IoT related capabilities may in turn be used to provide smart solutions by providing real time updates, big data analysis, and sensor-based data collection by using the cloud-based system for providing recommendation services. In general, IoT is a concept in which intelligent devices can monitor the events happening around them, fuse their sensor data, make use of local and distributed intelligence to decide on courses of action and then behave to manipulate or control objects in the physical world.

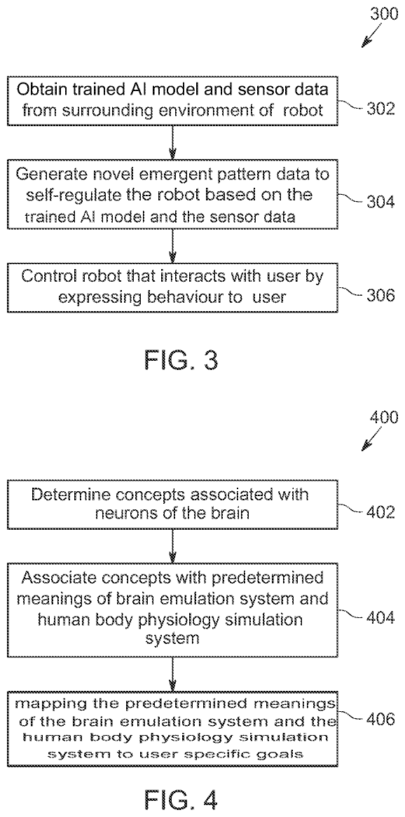

FIG. 3 illustrates a flowchart 300 for implementation of an exemplary method for controlling a robot through human emulation system, in accordance with an example embodiment. FIG. 3 is explained in conjunction with FIG. 1 and FIG. 2. The flowchart starts at 302.

At 302, a trained AI model and sensor data may be obtained from a surrounding environment of the robot 104. The processor 202 may be configured to obtain a trained AI model and the sensor data from the surrounding environment of the robot 104. The AI model 206 may be trained using the brain emulation data and the human body physiology simulation data.

At 304, novel emergent pattern data may be generated to self-regulate the robot. The novel emergent pattern data is generated based on the trained AI model 206 and the sensor data. Hence, the trained AI model 102A that considers the brain simulation data, the human body physiology simulation data, and interaction with the surrounding environment of the robot 104 which is a real world and gives rise to complex behavioral patterns in the robot 104 that may be hard to predict, instead of being simple and deterministic patterns.

At 306, the robot 104 may be controlled that interacts with the user 110 by expressing a behavior to the user 110. The processor 202 may be configured to control the robot 104 that interacts with the user 110 by expressing a behavior to the user 110, based on the novel emergent pattern data. In accordance with an embodiment, the expressed behavior of the robot 104 comprises spoken words and actuation of one or more of end effectors of the robot 104. In accordance with an embodiment, the expressed behavior of the robot 104 comprises change in facial expressions, such as smile on the face of the robot 104. The robot 104 may possess human like intellectual abilities, such as ability to learn anything, ability to reason, ability to use language and ability to formulate original ideas based on brain emulation and human body physiology simulation through AI model 206. The control passes to the end.

Accordingly, blocks of the flowchart 300 support combinations of means for performing the specified functions and combinations of operations for performing the specified functions. It will also be understood that one or more blocks of the flowchart 300, and combinations of blocks in the flowchart 300, can be implemented by special purpose hardware-based computer systems which perform the specified functions, or combinations of special purpose hardware and computer instructions.

Alternatively, the AI enabled human emulation system 102 may comprise means for performing each of the operations described above. In this regard, according to an example embodiment, examples of means for performing operations may comprise, for example, the processor 202, the memory 204 and/or a device or circuit for executing instructions or executing an algorithm for processing information as described above.

On implementing the flowchart 300 disclosed herein, the end result generated by the AI enabled human emulation system 102 is a tangible generation of novel emergent patterns to control the robot 104. The generation of novel emergent patterns is of utmost importance that considers the brain simulation, human body physiology simulation and interaction with the surrounding environment, which is a real world, gives rise to complex behavioral patterns in the robot 104 that may be hard to predict, instead of being simple and deterministic patterns.

FIG. 4 illustrates a flowchart 400 for implementation of an exemplary method for controlling the robot 104 using a brain emulation system 102B that facilitates the AI enabled human emulation system 104 to control the robot 104, in accordance with an example embodiment. FIG. 4 is explained in conjunction with FIG. 1 to FIG. 3. The flowchart starts at 402.

At 402, concepts associated with neurons of the brain may be determined. The brain emulation system 102B may be configured to determine the concepts associated with the neurons of the brain. The brain emulation system 102B may comprise elements and attributes associated with the brain. The elements may have trained relationship between concepts that have predetermined meanings.

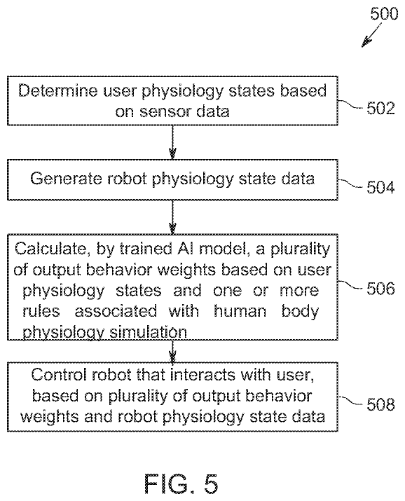

At 404, concepts may be associated with predetermined meanings of the brain emulation system and other trained AI models associated with the human body physiology simulation system. The brain emulation system 102B may be configured to associate the concepts with the predetermined meanings of the brain emulation system 102B and other trained AI models associated with the human body physiology simulation system 102C. The human body physiology simulation system 102C is explained in FIG. 5.

At 406, the brain emulation system 102B performs mapping of the predetermined meanings of the brain emulation system and the human body physiology system 102C with user specific goals. For generation of the novel emergent pattern data, the brain emulation system 102B may be further configured to synthesize the elements of the trained AI model and the other trained AI models, based on interactive manipulation of the elements with sensor data from the surrounding environment of the robot. The AI model 206 may be trained using the brain emulation data and the human body physiology simulation data. Hence, the trained AI model 102A that considers the brain simulation, human body physiology simulation and interaction with the surrounding environment, which is a real world, gives rise to complex behavioral patterns in the robot 104 that may be hard to predict, instead of being simple and deterministic patterns.

Accordingly, blocks of the flowchart 400 support combinations of means for performing the specified functions and combinations of operations for performing the specified functions. It will also be understood that one or more blocks of the flowchart 400, and combinations of blocks in the flowchart 400, can be implemented by special purpose hardware-based computer systems which perform the specified functions, or combinations of special purpose hardware and computer instructions.

Alternatively, the brain emulation system 102B may comprise means for performing each of the operations described above. In this regard, according to an example embodiment, examples of means for performing operations may comprise, for example, processor, memory and/or a device or circuit for executing instructions or executing an algorithm for processing information as described above.

FIG. 5 illustrates a flowchart 500 for implementation of an exemplary method for controlling the robot 104 using a human body physiology simulation system 102C for embodied cognition with a humanlike physiology that facilitates human emulation system to control a robot in a more humanlike way, in accordance with an example embodiment. FIG. 5 is explained in conjunction with FIG. 1 to FIG. 4. The flowchart starts at 502.

At 502, user physiology states may be determined at the human body physiology simulation system 102C based on the sensor data. The human body physiology simulation system 102C may be configured to determine the user physiology states based on the sensor data. The user physiology states may comprise at least one of hormones state, metabolism state, cardiovascular state, breathing rate, endocrine state, and dopamine state.

At 504, robot physiology state data may be generated at the human body physiology simulation system 102C. The human body physiology simulation system may be configured to generate robot physiology state data based on the determined user physiology states. The robot physiology states may be further based on feelings associated with the user physiology states for survival and learning. The feelings may correspond to at least one of fearfulness, anger, frustration, aggression, happiness, sadness, desire, pleasure, and pain. The survival and learning in the human body physiology simulation system may be mapped to the brain emulation system 102B for general intelligence in the robot.

At 506, a plurality of output behavior weights may be calculated at the human body physiology simulation system 102C. The human body physiology simulation system 102C may be configured to calculate, by the trained AI model, a plurality of output behavior weights based on the user physiology states and one or more rules associated with the human body physiology simulation system 102C.

At 508, the robot that interacts with the user is controlled at the human body physiology simulation system 102C. The human body physiology simulation system 102C is configured to control the robot that interacts with the user, based on the plurality of output behavior weights and the robot physiology state data.

Accordingly, blocks of the flowchart 500 support combinations of means for performing the specified functions and combinations of operations for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions.

Alternatively, the human body physiology simulation system 102C may comprise means for performing each of the operations described above. In this regard, according to an example embodiment, examples of means for performing operations may comprise, for example, processor, memory and/or a device or circuit for executing instructions or executing an algorithm for processing information as described above.

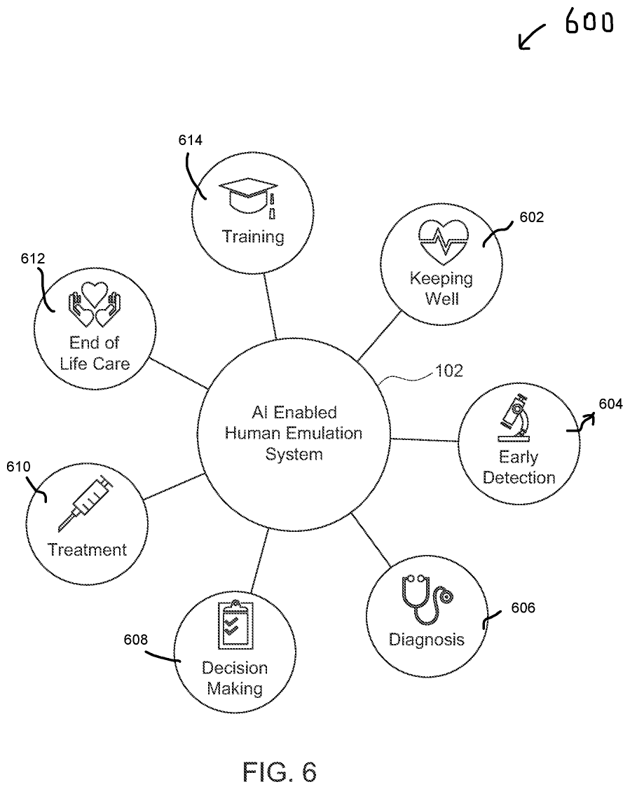

FIG. 6 illustrates an exemplary scenario 600 for implementation of an exemplary AI enabled human emulation system deployed in a healthcare ecosystem to control a robot in a more humanlike way, in accordance with an example embodiment. FIG. 6 is explained in conjunction with FIG. 1 to FIG. 5. There is shown the AI enabled human emulation system 102 that transforms different aspects when deployed in healthcare sector.

The AI enables human emulation system 102 has a keeping well 602 feature. The AI enabled human emulation system 102 utilizes the keeping well 602 feature to do things what humans do, however more efficiently, more quickly and at a lower cost than humans in the healthcare ecosystem. The AI enabled human emulation system 102 may aid in people staying healthy so they do not need a doctor, or at least not as often. The use of AI and the Internet of Medical Things (IoMT) in consumer health applications is already helping people. The AI enabled human emulation system 102 may encourage healthier behavior in individuals and help with the initiative-taking management of a healthy lifestyle which puts consumers in control of health and well-being. Additionally, the AI enabled human emulation system 102 allows healthcare professionals to better understand the day-to-day patterns and needs of the people they care for, and with that understanding they are able to provide better feedback, guidance, and support for staying healthy. The AI enabled human emulation system 102 may allow perception of emotional state of a human with which a robot (controlled by the AI enabled human emulation system 102) is interacting and a simulated emotional response by the robot to better facilitate interaction between the robot and a human (such as, a patient, a surgeon, a researcher, and a physician).

The AI enabled human emulation system 102 may be configured to control the robot to perform a particular task without being explicitly programmed. The AI enabled human emulation system 102 may be capable of performing tasks and cognitive functions that are otherwise only within the scope of human intelligence. The AI enabled human emulation system 102 may be able to learn capabilities automatically instead of having explicitly programmed end-to-end by using the brain emulation system 102B and the human body physiology simulation system 102C for embodied cognition with a humanlike physiology that facilitates training of the AI model in a more humanlike way. The AI model 102A may unleash actionable insights that would otherwise be trapped in massive amounts of data. In accordance with an embodiment, much of that data in the healthcare sector is unstructured data, that is, data that may be generated by drafted reports and business documents, videos, photos, social media posts or even e-mail messages.

The AI enabled human emulation system 102 may be configured to obtain the sensor data from the sensor unit to use vast amounts of health data and power diagnosis 606. The AI enabled human emulation system 102 may be configured to review and store far more medical information that may comprise medical journal, symptom, and case study of treatment and response around the world, exponentially faster than any human. The AI enabled human emulation system 102 may dynamically adapt and self-regulate to unpredictable interaction with the surrounding environment.

The AI enabled human emulation system 102 may work in partnership with clinicians, researchers, and patients to solve real-world healthcare problems. In accordance with an embodiment, the brain emulation system 102B of the AI model 102A uses general-purpose learning algorithms into neural networks that mimic the human brain. The AI model 102A may use the brain emulation system 102B comprising different layers in the network for analyzing and learning data. The brain emulation system 102B is inspired by the human brain where each layer may consist of its own artificial neurons that are interconnected and responsive to one another.

The AI enabled human emulation system 102 has a decision-making feature 608. The AI enabled human emulation system 102 utilizes the decision-making feature 608 to improve care that requires the alignment of health data with appropriate and timely decisions, and predictive analytics may support clinical decision-making and actions as well as prioritize administrative tasks. Clinical decision-making is a contextual, continuous, and evolving process, where all the data is collected, interpreted, and analyzed to select an evidence-based choice of action.

The AI enabled human emulation system 102 is configured to use pattern recognition to identify patients at risk of developing a condition or seeing the condition deteriorate due to lifestyle, environmental, genomic, or other factors. In accordance with an embodiment, the AI model 102A uses deep learning techniques that may allow the AI enabled human emulation system 102 to process information on a sophisticated level, allowing the controlled robot to perform complex functions.

The AI enabled human emulation system 102 has a treatment feature 610. The AI enabled human emulation system 102 utilizes the treatment feature 610 to take a more comprehensive approach to help clinicians for disease management, better coordinate care plans and help patients to manage and comply with their long-term treatment programs as compared to humans. Beyond scanning health records, the AI enabled human emulation system 102 allow providers to identify chronically ill individuals who may be at risk of an adverse episode.

In accordance with an embodiment, the AI enabled human emulation system 102 is configured to control a complex surgical robot that can either aid a human surgeon or execute operations by own. In addition to surgery, the AI enabled human emulation system 102 may be configured to control a robot that may be deployed in hospitals and labs for repetitive tasks, in rehabilitation, physical therapy and in support of patients with long term conditions.

Nowadays, people may be living much longer than previous generations, however as the people approach the end of life, they are dying in a different and slower way, from conditions like dementia, heart failure and osteoporosis. This phase of life may often be plagued by loneliness. The AI enabled human emulation system 102 may be configured to control the robot to revolutionize end of life care 612, helping people to remain independent for longer, reducing the need for hospitalization and care homes.

The AI enabled human emulation system 102 controls the robot to go even further and have conversations and other social interactions with people to keep aging minds sharp. The conversations and social interactions may be based on human body physiology simulation that facilitates human-like cognition in the robot 104 making it robust, autonomous, and saving the robot 104 from self-destruction. Because of the human-like cognition, the AI enabled human emulation system 102 may help the robot 104 in venturing into human environment autonomously and successfully. Moreover, the robot 104 may possess morphology similar to that of a human, the sensors, and material used on the robot 104 may resemble that of a human. This facilitates the human like cognition in the robot 104 that depends on the sensor data obtained from sensor unit 106, physiology simulation, neural activity of brain and the surrounding environment. The architecture of the AI enabled human emulation system 102 may seamlessly integrate into neural activity and psychology. The AI enabled human emulation system 102 may be configured to mimic the human body physiology.

The AI enabled human emulation system 102 with the help of the AI model 102A allows training 614 for the robot 104 through naturalistic simulations in a way that simple computer-driven algorithms cannot. The advent of natural speech and the ability of the robot 104 controlled by the AI enabled human emulation system 102 to draw instantly on a large database of scenarios, means the response to questions, decisions or advice from the robot may challenge in a way that a human cannot. The AI model 102A may use different AI subgroups in the AI model 102A to select best plan. To approximate the function of human biology system, software simulation of life may be performed by the AI model 102A. Apart from the biology systems, chemical systems and hybrid systems may be used by the AI model 102A of the AI enabled AI enabled human emulation system 102 to simulate artificial life to control the robot 104. The AI model 102A may be configured to model the artificial life to decipher simple and general principles underlying life and implement them in a simulation to analyze lifelike systems, such as brain emulation system 102B and human body physiology simulation system 102C. In accordance with an embodiment, the AI model 102A may establish ethical principles for artificial life.

Hence, the trained AI model 102A that considers the brain simulation, human body physiology simulation and interaction with the surrounding environment, which is a real world, gives rise to complex behavioral patterns in the robot 104 that may be hard to predict, instead of being simple and deterministic patterns. Therefore, the AI enabled AI enabled human emulation system 102 may be configured to generate novel emergent pattern data to self-regulate the robot 104 and adapt the robot 104 to the surrounding environment based on the trained AI model 102A and the sensor data. The generated novel emergent pattern data may be based on the trained AI model 102A that learns from experience. A pattern in the novel emergent pattern data may have an emergent property because that may be a result of a systematic interaction of the sub systems in the AI enabled AI enabled human emulation system 102.

In accordance with an embodiment, the AI model 102A may be configured to use machine learning algorithms to perform work associated with the healthcare sector. Different sub-groups of the AI model 102A may manage idiomatic expressions, medical applications to detect disease, and recommendation engines to support financial decision making. In addition, the AI enabled human emulation system 102, with the use of the AI model 102A, may be configured to train the robot how best to interact with humans. In accordance with an embodiment, the AI enabled human emulation system 102 may be configured to impart reinforcement learning to the robot, based on deep learning algorithms used by the AI model 102A.

The AI enabled human emulation system 102 may control the robot to develop a personality with qualities, which may be confident, caring, and helpful but not bossy. The brain emulation system 102B and human body physiology simulation system 102C of the trained AI model 102A may instill such qualities. Similarly, AI enabled human emulation system 102 may be configured to control the robot to ensure that the robot accurately reflects a brand of organization for which it is working. The AI enabled human emulation system 102 may be configured to control the robot to manage natural-language conversations, have access to vast stores of data and may answer many frequently asked questions. The AI enabled human emulation system 102 may be configured to control the robot to analyze a tone of voice of a patient (frustrated versus appreciative).

The AI enabled human emulation system 102 may be configured to control the robot that may be trained to display even more complex and subtle human traits, such as sympathy. For instance, if a user is having a bad day, the robot controlled by the AI enabled human emulation system 102 may not reply with a canned response such as “I'm sorry to hear that.” Instead the robot may ask for more information and then offer advice to help the person see his issues in a different light. In accordance with an example embodiment, when the user may be feeling stressed, the robot controlled by the AI enabled human emulation system 102 may recommend thinking of that tension as a positive emotion that could be channeled into an action. In accordance with an embodiment, the AI model 102A may be trained for pain and pleasures which are felt by humans and animals. The AI enabled AI enabled human emulation system 102 cannot feel the pain and pleasure because of absence of nervous system and may be trained to feel the pain and the pleasure. Pain may correspond to reduction in efficiency of the AI enabled AI enabled human emulation system 102 and pleasure may increase the efficiency of the AI enabled AI enabled human emulation system 102. Further, in accordance with another embodiment, based on simulated emotions in the robot 104, the AI enabled AI enabled human emulation system 102 may control the robot 104 to speak with a certain pitch, tone, volume, and speed. The AI enabled human emulation system 102 may use natural language processing techniques that mimic human speech patterns to simulate a human tone in machine-human interaction, which creates more intimate interactions. Consequently, it may generate information proactively, rather than in response to a prompt.

The AI enabled human emulation system 102 may enable the robot to interact with employees and customers in novel and effective way. The AI enabled human emulation system 102 may enable the robot to facilitate communication between people or on behalf of people, such as by transcribing a meeting.

The AI enabled human emulation system 102 may help hospitals detect if a dementia patient is wandering off site without a nurse and lock doors. The AI enabled human emulation system 102 may help sick patients easily navigate through a hospital. The AI enabled human emulation system 102 may display desired intelligent behavior as opposed to, for example, explicitly programming software with a bunch of rules to generate desired behavior, based on the novel emergent patterns. The AI enabled human emulation system 102 may be configured to determine sentiment expressed in text or images, or what objects are present in pictures.

The AI enabled human emulation system 102 may be useful in health care sector, where technological feasibility and ethical expectations can join forces productively, to achieve unprecedented levels of reach, in terms of population, and of tailoring, in terms of individualized care.

In accordance with an embodiment, the AI enabled human emulation system 102 may control the robot to be operated by a trained surgeon. Such usage of the robot by a trained surgeon may help in, but not limited to, reduced blood loss, lower risk of wound infection, quicker recovery times and saving healthy tissue from damage. The AI enabled human emulation system 102 may be configured to control the robot to assist surgeons in conducting precise surgical procedures.

The AI enabled human emulation system 102 may address the demand for high-quality and affordable healthcare in the country. The AI enabled human emulation system 102 may be configured to capture patient data using sensors in smartphones and wearable devices, remotely extracting information from patient records for monitoring health, supporting diagnosis, enabling health trackers, and predicting onset of symptoms, and powering patient connectivity with specialists. The AI enabled human emulation system 102 has an early detection feature 604. The AI model 102A utilizes the early detection feature 604 to detect conditions like cancer from medical imagery and reports and to develop customized treatment plans for individuals. Thus, AI enabled human emulation system 102 may enhance productivity and availability of physicians.

The AI enabled human emulation system 102 may be configured to be trained to translate input data into a desired output value. When given this data, the AI enabled human emulation system 102 may analyze and form context to point to relevant data to react to spoken or written prompts. Using deep learning within the AI model 102A (brain emulation system), the AI enabled human emulation system 102 may discover new patterns in the data without any prior information or training, then extracts and stores the patterns in the memory of the AI enabled human emulation system 102.

The AI enabled human emulation system 102 may be utilized by humans to expand their abilities in three ways, viz., amplify cognitive strengths of the humans; interact with customers and employees to free their time for higher-level tasks; and embody human skills to extend physical capabilities of the humans.

The disclosed system and method in the present disclosure firstly, learns hidden truth in a situation. Secondly, generates novel pattern in utility, such as survival of AI in complex environment, and pursuit of truth. Thirdly, enhances system performance because the AI generalizes well across applications and application domains and is not subject to problems of catastrophic forgetting and overfitting. The bio-inspired AI enabled human emulation system 102 may approximate the human brain with rough simulations of the human visual cortex, hippocampus and other structures and the human body physiology simulation which aids in human-like understanding, and adaptive to real life situations. Therefore the present disclosure relates to the emulation of real-world human thought process, perception of truths, and decision making using artificial intelligence software with a biologically inspired symbolic architecture.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. For example, the AI enabled human emulation system 102 may be configured to control the robot to interact with animals in a manner similar to interaction with humans. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An artificial intelligence (AI) enabled human emulation system, comprising:
at least one non-transitory memory configured to store computer-executable instructions; and
at least one processor configured to execute the computer-executable instructions to:
obtain a trained AI model and sensor data from a surrounding environment of a robot, wherein the trained AI model is trained using brain emulation data and human body physiology simulation data;
generate novel emergent pattern data to self-regulate the robot, wherein the novel emergent pattern data is generated based on the trained AI model and the sensor data; and
control the robot for enabling interaction between the robot and a user, wherein the robot interacts with the user by expressing a behavior to the user based on the novel emergent pattern data.

2. The AI enabled human emulation system of claim 1, wherein the trained AI model is selected from a plurality of trained AI subgroups, and wherein the plurality of trained AI subgroups comprise a brain emulation system and a human body physiology simulation system.

3. The AI enabled human emulation system of claim 1, wherein the trained AI model comprises at least one of a machine learning model, a deep learning model, a knowledge processing model, a computational model that approximates function of human biology system, perception algorithm or a bio-inspired engineered algorithm.

4. The AI enabled human emulation system of claim 2, wherein the brain emulation system is further configured to:
determine concepts associated with neurons of the brain;
associate the concepts with predetermined meanings of the brain emulation system and the human body physiology simulation system; and
associate the predetermined meanings of the brain emulation system and the human body physiology simulation system with user specific goals.

5. The AI enabled human emulation system of claim 2, wherein the human body physiology simulation system is further configured to:
determine user physiology states based on the sensor data;
generate robot physiology state data based on the determined user physiology states;
calculate, by the trained AI model, a plurality of output behavior weights based on the user physiology states and one or more rules associated with the human body physiology simulation system; and
control the robot that interacts with the user, based on the plurality of output behavior weights and the robot physiology state data.

6. The AI enabled human emulation system of claim 5, wherein the user physiology states correspond to at least one of hormones state, metabolism state, cardiovascular state, breathing rate, endocrine state, and dopamine state.

7. The AI enabled human emulation system of claim 6, wherein the robot physiology states are based on feelings associated with the user physiology states for survival and learning, wherein the feelings correspond to at least one of fearfulness, anger, frustration, aggression, happiness, sadness, desire, pleasure, and pain.

8. The AI enabled human emulation system of claim 7, wherein the survival and learning in the human body physiology simulation system are mapped to the brain emulation system in the AI model trained for general intelligence in the robot.

9. The AI enabled human emulation system of claim 1, wherein the expressed behavior of the robot comprises spoken words and actuation of one or more of end effectors in a robot.

10. A method for controlling a robot with human emulation, the method comprising:
obtaining a trained AI model and sensor data from a surrounding environment of the robot, wherein the trained AI model is trained on brain emulation data and human body physiology simulation data;
generating, by one or more processors, novel emergent pattern data to self-regulate the robot based on the trained AI model and the sensor data; and
controlling the robot for enabling interaction between the robot and a user, wherein the robot interacts with the user by expressing a behavior to the user, based on the novel emergent pattern data.

11. The method of claim 10, wherein the trained AI model is selected from a plurality of trained AI subgroups, and wherein the plurality of trained AI subgroups comprise a brain emulation system and a human body physiology simulation system.

12. The method of claim 10, further comprising:
determining, at the brain emulation system, the concepts associated with neurons of the brain;
associating, at the brain emulation system, the concepts with predetermined meanings of the brain emulation system and the human body physiology simulation system; and
mapping, at the brain emulation system, the predetermined meanings of the brain emulation system and the human body physiology simulation system with user specific goals.

13. The method of claim 10, further comprising:
determining, at a human body physiology simulation system, user physiology states based on the sensor data;
generating, at the human body physiology simulation system, robot physiology state data based on the determined user physiology states;
calculating, at the human body physiology simulation system, by the trained AI model, a plurality of output behavior weights based on the user physiology states and one or more rules associated with the human body physiology simulation system; and
controlling, at the human body physiology simulation system, the robot that interacts with the user, based on the plurality of output behavior weights and the robot physiology state data.

14. The method of claim 13, wherein the user physiology states correspond to at least one of hormones state, metabolism state, cardiovascular state, breathing rate, endocrine state, and dopamine state.

15. A computer programmable product comprising a non-transitory computer readable medium having stored thereon computer executable instructions, which when executed by one or more processors, cause the one or more processors to perform a method for controlling a robot with human emulation, the method comprising:
obtaining a trained AI model and sensor data from a surrounding environment of the robot, wherein the trained AI model is trained on brain emulation data and human body physiology simulation data;
generating novel emergent pattern data to self-regulate the robot based on the trained AI model and the sensor data; and
controlling the robot that interacts with a user by expressing a behavior to the user, based on the novel emergent pattern data.
